(19) United States
(12) Patent Application Publication
(10) Pub. No.: US 2021/0265730 A1
(43) Pub. Date: Aug. 26, 2021

(54) MATCHING CIRCUIT FOR ANTENNA

(71) Applicant: SITRONIX TECHNOLOGY CORP., Jhubei City (TW)

(72) Inventors: CHUNG-HSIN SU, JHUBEI CITY (TW); CHIH-WEI KU, JHUBEI CITY (TW)

(21) Appl. No.: 17/062,735

(22) Filed: Oct. 5, 2020

Related U.S. Application Data
(60) Provisional application No. 62/911,175, filed on Oct. 4, 2019.

(51) Int. Cl. H01Q 5/335; H01Q 5/50; H04B 1/00

(52) U.S. Cl. CPC H01Q 5/335; H04B 1/006; H01Q 5/50

(57) ABSTRACT

The present application discloses a matching circuit for antenna, which is integrated into a single chip; the matching circuit comprising: a capacitor bank having a plurality of capacitor cells, a selecting circuit coupled to the capacitor cells and selecting the at least some of the capacitor cells.

### FIELD OF THE INVENTION

The present application refers to a matching circuit, particularly a matching circuit for an antenna.

### BACKGROUND OF THE INVENTION

Nowadays, more and more mobile end products are applied widely, such as cell phones, smartphones, smart bracelets, smart watches, tablets and laptops, their signal transmissions are relied on antennas for transmitting texts data, numerical data or image data, even to transmit video data.

In general, due to the fact that the impedances of a Radio Frequency (RF) circuit and an antenna are not the same as each other, and do not match each other, thereby, a matching circuit is required to match the impedances of the RF circuit and the antenna, for optimizing the signal transmission efficiency between the RF circuit and the antenna. The traditional matching circuit includes a plurality of capacitors set on the circuit board. Since the capacitance of capacitor of the matching circuit is determined by the antenna impedance and the RF circuit impedance, when the antenna impedance is changed, for example, the RF circuit is matched with different antennas, and the matched antennas have different impedances. Thereby, the capacitors of the matching circuit must be changed to determine different capacitance for the antenna, that is, the capacitors of the matching circuit have to be replaced by another one with appropriate capacitance. In this way, a variety of capacitors must be prepared with significant cost increasing. Moreover, a plurality of capacitors are set on the circuit board of a traditional matching circuit, and the manufacturing process and the manufacturing cost would be increased, such as the bonding process and the cost of bonding, and the amount of electronic components set on the circuit board is increased, and the cost of the components is also increased, further, the electronic components are easily got damaged, which cause that the reliability of matching circuit is lowered down.

Due to the aforesaid reasons, in the market, a matching circuit with a changeable capacitance is urgently needed to meet different impedance requirements. The present application provides a matching circuit for an antenna to solve the aforesaid problems.

### SUMMARY

One purpose of the present application is to provide a matching circuit for an antenna that the impedance would be adjusted to meet the required capacitance of the matching circuit without changing the electronic devices in matching circuit and thus, the cost is reduced.

One purpose of the present application is to provide the matching circuit for the antenna that would be integrated in the chip, for reducing the amount of the electronic device set on the matching circuit, and for simplifying the manufacturing process to reduce the cost of the matching circuit and improve the reliability of the matching circuit.

One embodiment of the present application is to disclose an antenna matching circuit, consisting of: a capacitor bank with a plurality of capacitor cells; a selecting circuit coupled to the capacitor cells and select all or part of the capacitor cells.

### BRIEF DESCRIPTION OF THE DRAWINGS

FIG. 1: which is a schematic diagram of a matching circuit for an antenna and a RF circuit in one embodiment of the present application;

FIG. 2: which is a schematic diagram of the matching circuit in one embodiment of the present application;

FIG. 3: which is a circuit diagram of a selecting circuit and a capacitor bank in one embodiment of the present application;

FIG. 4: which is a schematic diagram of a decoding table in one embodiment of the present application;

FIG. 5: which is a schematic diagram of the selecting circuit and the capacitor bank in other one embodiment of the present application;

FIG. 6: which is a circuit diagram of the selecting circuit and the capacitor cell group as shown in FIG. 5;

FIG. 7: which is a schematic diagram of the matching circuit integrated in the RF circuit in the other embodiment of the present application;

FIG. 8: which is a schematic diagram of the matching circuit integrated in the panel driving circuit in the other embodiment of the present application; and

FIG. 9: which is a schematic diagram of the matching capacitor within the matching circuit in one embodiment of the present application;

### DETAILED DESCRIPTION

Some terms are used in the invention description and claims to specify certain devices; yet, anyone in the field of the present application with common knowledge shall be able to understand the terms; manufacturers may use different terms to call the same device, and the present application description and claims don't use the name variety as the criterion of distinction, instead, the present application description and claims use the difference in overall technology as the criterion. The “include” mentioned in the entire invention description and claims is an open term, which shall be explained as “include but not limited to”. Moreover, the “coupled to” stated herein includes the direct and indirect methods. Therefore, if there is an expression of “a primary device is coupled to the secondary device”, it means that the primary device connects the secondary device directly or via other device or connecting way to connect to the secondary device indirectly.

The present application relates to a matching circuit for an antenna, which comprising a selecting circuit selecting at least part of capacitor cells in a capacitor bank for determining the impedance of the matching circuit to match the antenna and the RF circuit, to preventing from the problem that the capacitors within the matching circuit must be changed in responsive to different impedance of the antenna; in addition, the present application provides the matching circuit integrated in a chip to simplify the process of setting the matching circuit onto the circuit board, to reduce the amount of the electronic devices set on the circuit board and to improve the reliability.

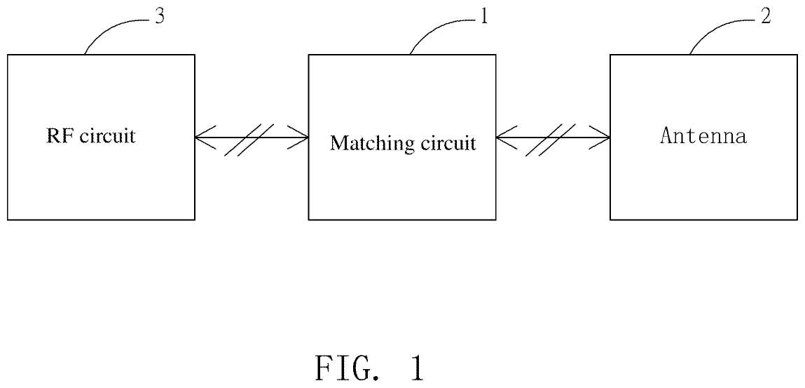

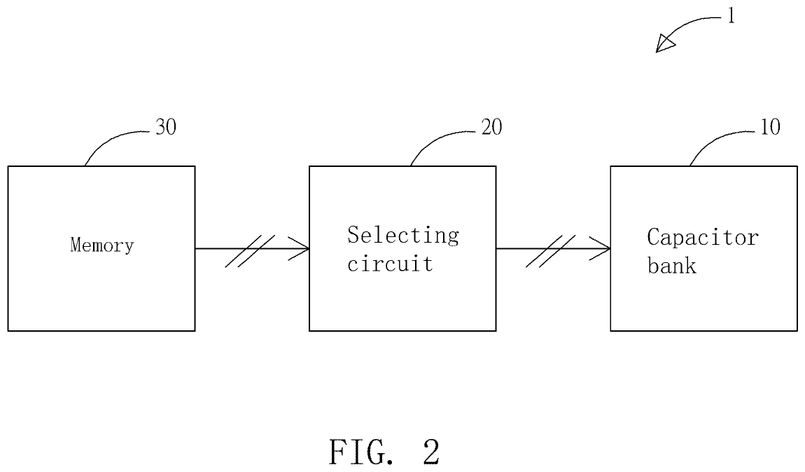

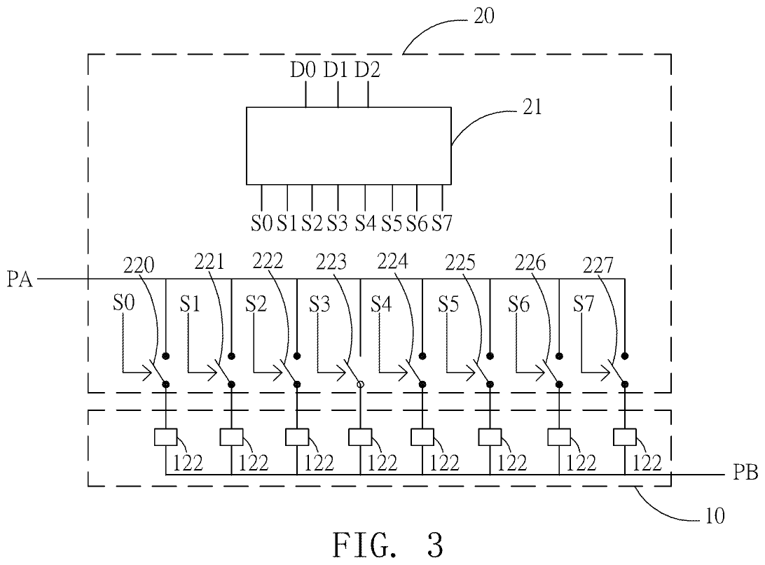

First, refer to FIG. 1, which is the schematic diagram of the matching circuit for the antenna and the RF circuit in one embodiment of the present application. As shown in the figure, the matching circuit 1 is coupled between a Radio Frequency (RF) circuit 3 and an antenna 2, for matching the impedances between the antenna 2 and the RF circuit 3, for optimizing the transmitting efficiency between the RF circuit 3 and the antenna 2. In one embodiment of the present application, the matching circuit 1 is coupled between a transmission port of the RF circuit 3 and a transmission port of antenna 2. The RF circuit 3 generates and transmits a RF signal to the antenna 2 through the matching circuit 1 to make the antenna 2 emit the RF signal. The antenna 2 receives and transmits a wireless signal to the RF circuit 3 through the matching circuit 1; and the RF circuit 3 processes the wireless signal received by the antenna 2. As shown in FIG. 2, the matching circuit 1 includes a capacitor bank 10 and a selecting circuit 20. The capacitor bank 10 has a plurality of capacitor cells 122 (as shown in FIG. 3), the selecting circuit 20 is coupled to the capacitor cells 122 and selects at least part of the capacitor cells 122 to determine a capacitance of a matching capacitor. In one embodiment of the present application, the capacitor cells 122 are capacitors with fixed capacitances, the capacitances of the capacitor cell 122 are equivalent or different. In this embodiment, the capacitances in the capacitor cells 122 are equivalent.

Refer to FIG. 2, the matching circuit 1 further includes a memory 30. Such as, a non-volatile memory. The memory 30 stores at least one selecting parameter; the selecting circuit 20 is coupled to the memory 30, and selects at least part of the capacitor cells 122 according to the selecting parameter. The capacitor bank 10 and the selecting circuit 20 in the matching circuit 1 of the present application may be integrated into a chip, it is not required that many capacitors are set on a circuit board. Thus, the amount of the electronic devices set on circuit board may be reduced, the manufacturing process may be simplified, the manufacturing cost may be lowered and the reliability of the matching circuit 1 may be improved. In addition, the memory 30 further may be integrated into the same chip.

Refer to FIG. 3. which is the circuit diagram of the selecting circuit and the capacitor bank in one embodiment of the present application. As shown in FIG. 3, a second end of the capacitor cells 122 in the capacitor bank 10 are coupled to a second end PB. The selecting circuit 20 includes a decoding circuit 21 and a plurality of switching circuits, in this embodiment, the switching circuits may be a plurality of switches 220˜227; the decoding circuit 21 is coupled to the switches 220˜227, and each of the switches 220˜227 is coupled between the first end of capacitor cells 122 and the first end PA. Decoding circuit 21 receives and decodes a selecting parameter d0˜d2 and generates a plurality of switch signals s0˜s7; switch signals s0˜s7 control switch 220˜227 to turn on or off (cutoff) the path between the first end of capacitor cells 122 and the first end PA, therefore, selecting circuit 20 may select part of capacitor cells 122 coupled between the first end PA and the second end PB, that is, the selected capacitor cells 122 will be coupled in parallel connection to determine a capacitance of a matching capacitor. In one embodiment of the present application, the switches 220˜227 may be served by transistors.

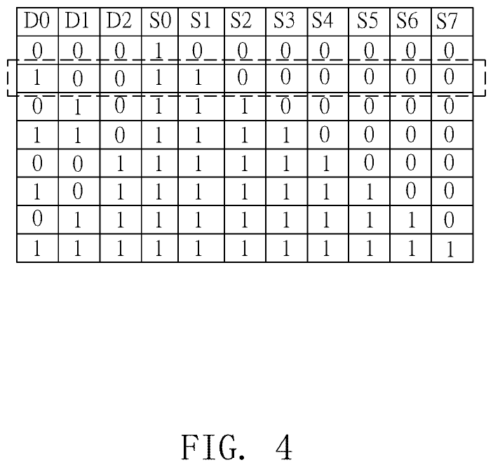

Refer to FIG. 4, which is the schematic diagram of the decoding table in one embodiment of the present application. As shown in FIG. 4, the decoding table of the decoding circuit 20 shows the relation between selecting parameter d0˜d2 and switch signals s0˜s7. When the switch signals s0˜s7 are 0, the levels of the switch signals s0˜s7 are “disable”, for example, a low level, for controlling the switches 220˜227 to be “turned-off”. When the switch signals s0˜s7 are 1, the levels of the switch signals s0˜s7 are “enable”, for example, a high level, for controlling the switches 220˜227 to be “turned-on”. For example. if the decoding parameter d0˜d2 is 100, the decoding circuit 21 decodes the decoding parameter d0˜d2 and generates the switch signals s0˜s7, in which the levels of the switch signals s0˜s1 are in “enable” level and control switch 220˜221 to be “turned-on”, let the two capacitor cells 122 coupled to the switch 220, 221 be coupled in parallel connection, and the levels of the switch signals s2˜s7 are “disable” that control the switch 222˜227 to be “turned-off”.

From the above statement, the selecting circuit 20 may select at least part of the capacitor cells 122 according to the predetermined selecting parameter d0˜d2 and determine the capacitance of the matching capacitor. The selecting parameters d0˜d2 are determined according to the impedances of the antenna 2 and the RF circuit 3; the selecting parameter d0˜d2 may be pre-stored in the memory 30 of matching circuit 1. if the impedance of rf circuit 3 or antenna 2 changes, while changing selecting parameter d0˜d2, the selecting circuit 20 will select the capacitor cells 122 with a proper amount according to the selecting parameter d0˜d2 to provide a proper impedance that matches the impedances of the antenna 1 and the RF circuit 3 rather than change the electronic devices of the matching circuit 1. although this embodiment selecting parameters d0˜d2 of three bits, 8 switch signals s0˜s7, 8 switches 220˜227 and 8 capacitor cell 122 are used in the example illustration, however, any skilled one in the art of the present application with common knowledge shall understand that mentioned embodiment is only used for embodiment and not to restrict the scope of the present application; in other embodiments, there are selecting parameters with more bits and more switch signals and capacitor cells used therein.

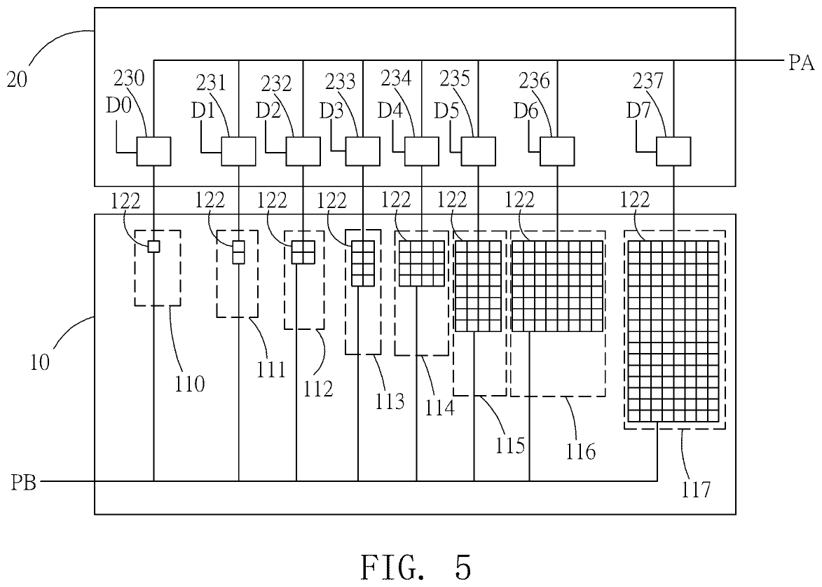

Refer to FIG. 5, which is a schematic diagram of the selecting circuit and the capacitor bank in other embodiment of the present application; in this embodiment, the identical part to above embodiment is neglected with repeated description; the similar devices are labeled with similar names and labeled numbers, thereby, only the different part description is illustrated. The capacitor cells 112 of the capacitor bank 10 in this embodiment are the capacitor cell groups 110˜117; each of the capacitor cell groups 110˜117 includes at least one capacitor cell 112, the amounts of the capacitor cells 112 in the capacitor cell groups 110˜117 are equivalent or different. In this embodiment, the amounts of the capacitor cell 112s in the capacitor cell groups 110˜117 have a geometric series relationship of 2, and the amounts of the capacitor cells 112 included in the capacitor cell groups 110˜117 are) 1(2⁰), 2(2¹) 4(2²), 8(2³), 16(2⁴), 32(2⁵), 64(2⁶) and 128(2⁷), respectively. For the embodiment stated above, the second end of each capacitor cell 112 is coupled to the second end PB.

The selecting circuit 20 in this embodiment includes a plurality of switching circuits 230˜237, and the switching circuits 230˜237 are coupled to the capacitor cell groups 110˜117, furthermore, the switching circuits 230˜237 are coupled to first end PA; the switching circuits 230˜237 are controlled by a plurality of switch signals d0˜d7. In one embodiment of the present application, the selecting parameters are stored in memory 30 may be 8-bit parameters used as the switch signals d0˜d7. The selecting circuit 20 in this embodiment controls the switching circuits 230˜237 to be turned on or turned off according to the selecting parameters to select at least one of the capacitor cell groups 110˜117, thus, it may determine the capacitance of a matching capacitor. For example, if the level of the switch signals d0˜d1 is “enable” whereas the level of switching signal d2˜d7 is “disable”, the switching circuit 230,231 are turned on and switching circuit 232˜237 are turned off, which is used to select the capacitor cell groups 110,111 coupled in parallel connection.

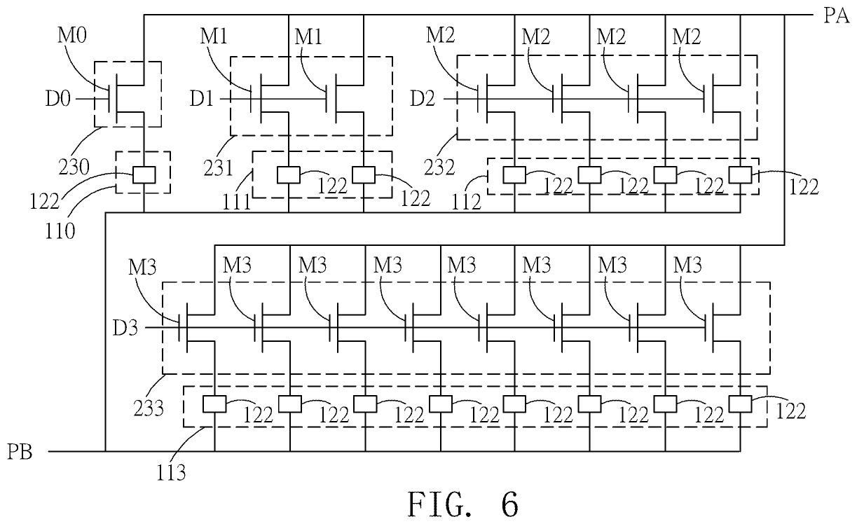

Refer to FIG. 6. which is the circuit diagram of the selecting circuit and the capacitor cell groups in FIG. 5. As shown in FIG. 6, each of the switching circuits 230˜233 include at least one switch, thereby, the switch amount in each of the switching circuits 230˜233 is identical to the amount in the capacitor cell 122 of the capacitor cell groups 110˜113; the switches may be served by transistors. In this embodiment, the switching circuit 230 includes a switch m0 is coupled between the first end of a capacitor cell 122 in the capacitor cell group 110 and the first end PA. The switching circuit 231 includes two switches m1, the switches m1 are coupled between the first end of the capacitor cells 122 in the capacitor cell group 111 and the first end PA. The switching circuit 232 includes four switches m2, the switches m2 are coupled between the first ends of four capacitor cell 122s in the capacitor cell group 112 and the first end PA. The switching circuit 233 includes eight switches m3, the switches m3s are coupled between the first ends of the eight capacitor cells 122 in the capacitor cell groups 113 and the first end PA. Same for the rest which won't be repeatedly stated herein. From above statement, it is noted that a capacitor cell in this embodiment corresponds to a switch, when using this way to select a plurality of capacitor cells, and the impedances of the selected capacitor cells (including switch for selecting purpose) are equivalent or very close, therefore, it may improve the accuracy of the matching circuit 1.

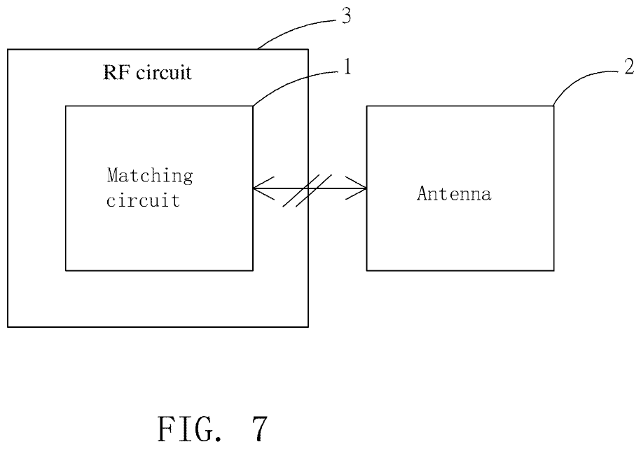

Refer to FIG. 7, which is the schematic diagram of integrated matching circuit within the RF circuit in the other embodiment of the present application. As shown in FIG. 7, the matching circuit 1 in the present application is integrated with the RF circuit 3 into single chip. This may reduce the amount of the electronic devices on the circuit board of the matching circuit 1 and simplify the process of setting the matching circuit 1 on circuit board, reduce cost and damage possibility and upgrade production yield and reliability.

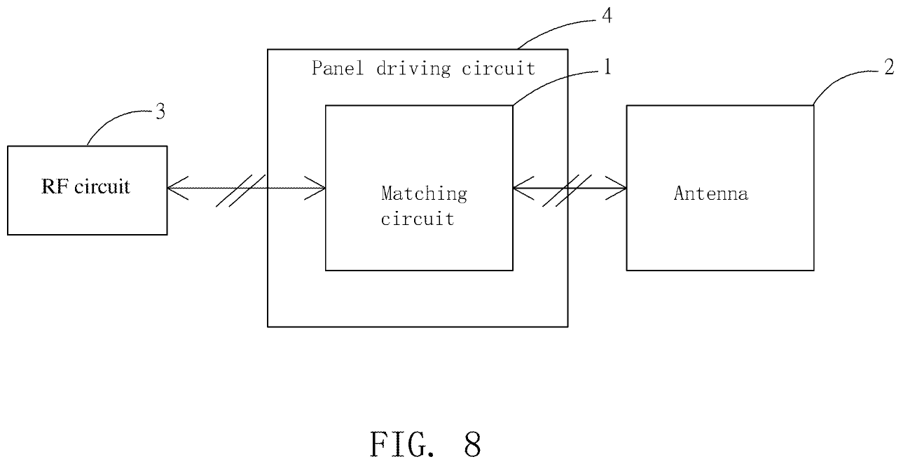

Refer to FIG. 8, which is the schematic diagram of integrated matching circuit within the panel driving circuit in the other embodiment of the present application. As shown in FIG. 8, the matching circuit 1 in the present application may integrate the panel driving circuit 4 into single chip. This may reduce the amount of the electronic devices on the circuit board of the matching circuit 1 and simplify the process of setting the matching circuit 1 on circuit board, reduce cost and damage possibility and upgrade production yield and reliability. The panel driving circuit 4 is coupled to the display panel and it may drive the display screen of display panel.

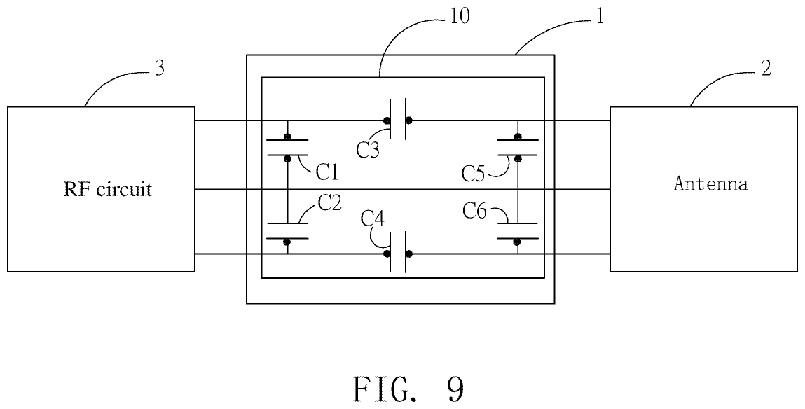

Refer to FIG. 9, which is the schematic diagram of matching capacitor within the matching circuit in one embodiment of the present application. As shown in FIG. 9, the matching circuit 10 includes at least one matching capacitor. In this embodiment, the matching circuit 10 includes six matching capacitors c1˜c6. the capacitor cells 122 of the capacitor bank 10 stated in the aforesaid embodiment are used to drive a matching capacitor, the selecting circuit 20 selects at least some capacitor cell 122 in capacitor bank 10 to determine the capacitance of matching capacitor, therefore, this matching capacitor is like a variable capacitor. In this embodiment. since matching circuit 10 includes the six matching capacitors c1˜c6, therefore, the capacitor bank 10 includes six capacitor cell zones, each capacitor cell zone includes the capacitor cells in aforesaid embodiment, used as the matching capacitors c1˜c6; the selecting circuit 20 may select at least some capacitor cells in six respective capacitor cell zones in accordance with the six selecting parameters, for respectively determining the capacitances of the matching capacitor c1˜c6. The aforesaid selecting parameters may be pre-stored in the memory 30. This embodiment uses the matching capacitor c1˜c6 as example in detailed description, yet it doesn't restrict the amount and connecting relation of the matching capacitor; designer may make varied design according to different matching requirements; the number of matching capacitors and the correlated connections are determined by matching requirements.

1. A matching circuit for an antenna, integrated into a chip, the matching circuit comprising:
a capacitor bank, having a plurality of capacitor cells; and
a selecting circuit, coupled to the capacitor cells and selecting at least part of the capacitor cells.

2. The antenna matching circuit of claim 1, wherein the part of the capacitor cells selected by the selecting circuit is coupled in parallel connection to determine a capacitance of a matching capacitor.

3. The antenna matching circuit of claim 1, wherein the selecting circuit comprises a plurality of switches; the switches are coupled to the capacitor cells.

4. The antenna matching circuit of claim 3, wherein the selecting circuit further comprises a decoding circuit, coupled to the switches and decoding a selecting parameter for controlling the switches.

5. The antenna matching circuit of claim 1, further including a memory, coupled to the selecting circuit and storing a selecting parameter, the selecting circuit selecting the least part of the capacitor cells according to the selecting parameter.

6. The antenna matching circuit of claim 1, wherein the capacitor cells are divided into a plurality of capacitor cell groups, each of the capacitor cell groups comprises at least one capacitor cell; the amounts of the capacitor cell of different capacitor cell groups are equivalent or different; the selecting circuit selects at least one capacitor cell group from the capacitor cell groups.

7. The antenna matching circuit of claim 1, wherein the matching circuit is coupled between a radio frequency circuit and an antenna.

8. The antenna matching circuit of claim 7, wherein the matching circuit and the radio frequency circuit are integrated into the chip.

9. The antenna matching circuit of claim 1, wherein the matching circuit is integrated into a panel driving circuit.

10. The antenna matching circuit of claim 1. wherein the matching circuit includes at least one matching capacitor, each matching capacitor includes the capacitor cells, the at least part of the capacitor cells is selected by the selecting circuit and coupled in parallel connection to determine a capacitance.
